(19) United States
(12) Patent Application Publication
(10) Pub. No.: US 2011/0115628 A1
(43) Pub. Date: May 19, 2011

(54) High-security self-adhesive stickers

(76) Inventor: Bennett L. Smith, Knoxville, TN (US)

(21) Appl. No.: 12/799,036

(22) Filed: Apr. 19, 2010

Related U.S. Application Data
(60) Provisional application No. 61/281,539, filed on Nov. 19, 2009.

(51) Int. Cl. G08B 13/00

(52) U.S. Cl. 340/541

(57) ABSTRACT

The invention comprises two different versions of a self-adhesive label, or “sticker,” that may be manufactured in various dimensions and may be utilized to seal and protect the confidentiality of documents and other papers contained in file folders or other such storage media:

1. The “High Tech” version, which contains a small “chip,” or transmitter, that sends a date-and-time signal to a computer “base” when cut, revealing a breach of or attempted tampering with the sticker. This version may or may not contain the carbon composite fibers as described in version No. 2, below.

2. The “Low Tech” version, which contains no “chip,” but utilizes thin, strong carbon composite fibers woven into the layers of the sticker during the manufacturing process. The sticker must be cut with a sharp instrument, and cannot be torn open manually.

High-security, strong self-adhesive stickers for the protection of confidential documents, diagrams and other printed or hand-written papers, in two versions:

1. “High Tech” version: basic strong self-adhesive label or “sticker,” sized 2″ H by 4″ W in the example (but could be manufactured in various other dimensions), which must be cut in order to be opened or otherwise removed. The sticker contains a small computerized “chip,” or transmitter, which sends a date-and-time signal to the mainframe or other computer (the “base”) programmed to receive that signal when the sensor wires are cut (any breach of the sensor wires interrupts an electrical current, causing the chip to transmit the date and time information to the base).

The “High Tech” version may, but does not necessarily have to, contain the carbon composite fibers as described in version No. 2, below, depending upon the preferences of the end-use consumer. It is intended that these “High Tech” stickers would be sold in pre-cut sheets of 10, 20 or other numbered versions, depending on the preference of the end-use consumer.

2. “Low Tech” version: basic strong self-adhesive label or “sticker,” sized 2″ H by 4″ W in the example (but could be manufactured in various other dimensions), which contains thin but strong carbon composite fibers woven through the layers of the sticker during the manufacturing process. Due to the presence of these fibers, the sticker must be cut with scissors, a knife or other sharp instrument, and cannot be ripped or torn manually.

It is intended that these “Low Tech” carbon composite fiber-woven stickers would be sold in pre-cut sheets of 10, 20 or other numbered versions, depending on the preference of the end-use consumer.

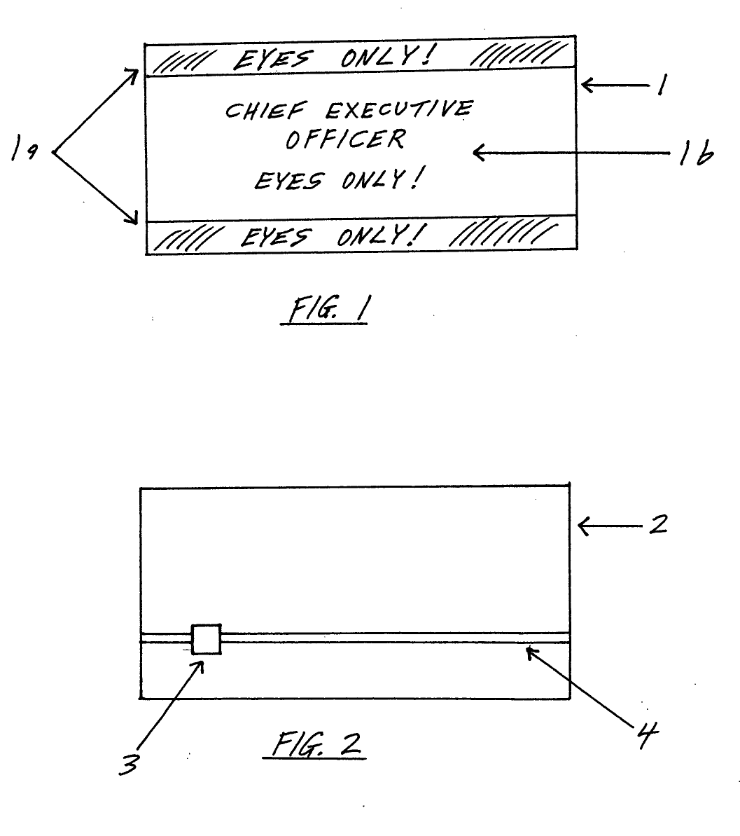

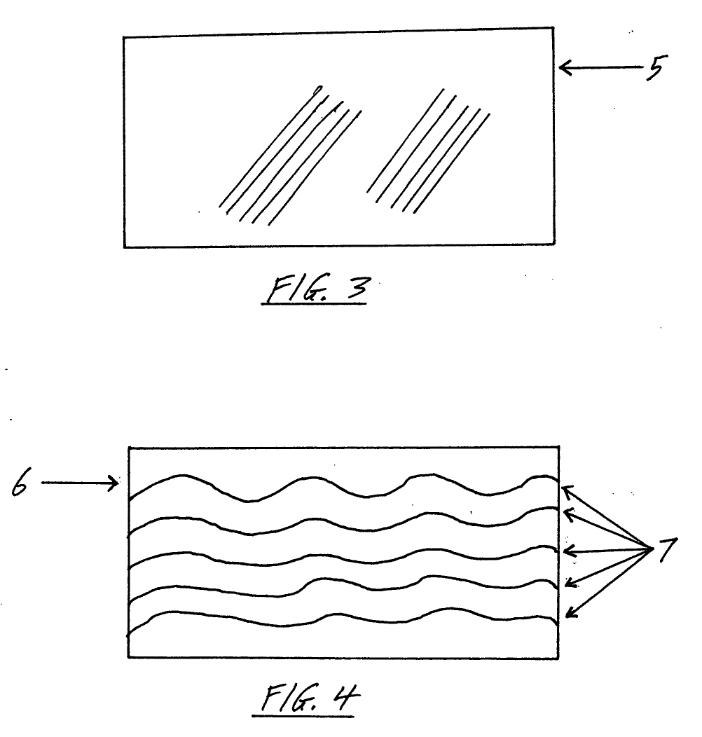

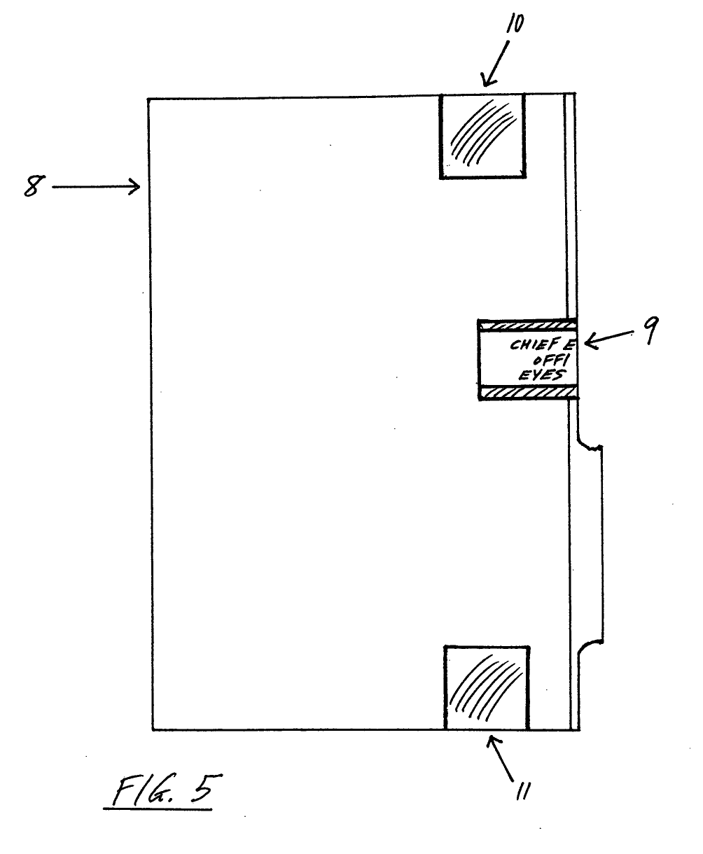

1. The inventor makes the following claims as applied to the above-described invention:
A. The “High Tech” version (Para. 1., above) provides the end-use consumer with a security sticker that precludes access to any file containing confidential or other important information that should not be disclosed to anyone not authorized to view such information without precise knowledge on the part of the person or entity protecting the information as to the date and time said access was gained, since access cannot be had without physically altering the sticker by fully cutting through the sticker, thereby triggering the contained computer chip (“transmitter”). The “High Tech” version provides a relatively inexpensive deterrent to theft of the file's contents, establishing an exact date and a precise time when the security sticker is breached, and is a strong anti-corporate espionage measure.
B. The “Low Tech” version (Para. 2., above) provides the end-use consumer with a lower-cost security sticker which precludes access to any file containing confidential or other important information that should not be disclosed to anyone not authorized to view such information without physically altering the sticker by fully cutting through the composite carbon fiber-woven sticker, since it cannot be torn open manually, thereby giving clear and incontrovertible evidence of tampering. As with the “High Tech” version (“A.,” above) the “Low Tech” version provides a very inexpensive deterrent to theft of the file's contents, may be used in conjunction with the “High Tech” version (FIG. 5), or independently, and is a strong anti-corporate espionage measure.
